(19) United States
(12) Patent Application Publication
(10) Pub. No.: US 2011/0232102 A1
(43) Pub. Date: Sep. 29, 2011

(54) Serving Placemat and Food Service Article

(76) Inventor: Larry Holmes, Covington, WA (US)

(21) Appl. No.: 12/731,433

(22) Filed: Mar. 25, 2010

(51) Int. Cl. B26B 11/00; B65D 6/04

(52) U.S. Cl. 30/123; 206/567

(57) ABSTRACT

This invention relates to a serving placemat and ribbed tray receptacle that provides a portable eating area for young children and adults with special eating needs. The tray separates and traps food and liquid spillage that falls through the placemat and is readily disassembled for cleaning. This product speeds cleanup of table tops after eating meals. A tethered eating implement may be attached to the food service article.

### FIELD OF THE INVENTION

This invention is related to a placemat for food service with supporting receptacle adapted for separating liquids from solids and sequestering liquids for disposal.

### BACKGROUND

Food service can be an onerous task if complicated by cleaning up spilled liquid, crumbs, and other residues. A means for reducing the work of cleanup has been long sought. Bezdek, in U.S. Pat. No. 4,887,315, describes a tray held with straps around the neck for catching food spilled by the driver of a vehicle. Sussman, in U.S. Pat. No. 5,497,885, describes a lap tray for eating when there is risk of spillage, which relies on a raised lip to prevent food from falling off the tray. Other efforts have focused on securing the eating utensils. Stone for example, in U.S. Pat. No. 2,684,110, describes a baby chair where the eating dish is countersunk and interlockedly affixed to the tray of the chair, and may be covered during play. Russell, in U.S. Pat. No. 5,975,628 describes a system of interlocking elements which lock eating utensils to a tray surface so that a child cannot knock utensils over and spill the contents. These efforts have limited use where solid foods and liquid vessels are to be provided and any liquid and solid waste is to be separated during cleanup. No provision for washing, as in a dishwasher, is made.

Accordingly, it is desirable to provide a sanitary serving placemat which keeps liquid and solid spills contained and separates liquids from solids, sequestering larger volumes of liquids for later disposal, thus easing the burden of cleanup for parents and caretakers.

### SUMMARY

A sanitary placemat is provided that includes a level surface for serving food, a catchment receptacle for capturing and sequestering spillage, and optionally a detachable tethered implement for eating. The food serving surface is perforated to allow easy drainage, the receptacle is ribbed to rigidly support the serving surface and has sufficient volume for typical spills. The tether is long enough to permit easy use but not so long that the eating utensil is not easily retrieved without contamination if thrown or dropped.

An object of this invention is to provide a sanitary placemat for a child or person to eat, and which allows freedom to make mistakes, mishaps, spills and messes and relieves the concern about clean up. This article reduces the mess by sequestering liquid and food spills within its tray receptacle; and therefore making clean up less “work” for the parent or guardian. Captured spillage may be carried away to a sink or place of cleaning and disposed of.

Children also repeatedly drop or throw their eating utensil onto the floor. The dropping of the eating utensil causes the parent or guardian to repeatedly pick up the utensil, wipe it off to be used, and return the contaminated utensil to the child, or go get a clean one.

The placemat also can be used for students, aging adults or those with handicaps and have special needs for eating and is adapted for food service in institutions and at home. Additionally, it may be used in places of incarceration.

In one embodiment the sanitary placemat includes a tray with central receptacle, a perforated serving support plate resting on the tray, and a tether which attaches a spoon, straw, or other eating utensil to the placemat. The central receptacle is defined by a bottom member and an enclosing frame. The bottom member is framed on all sides by a peripheral inside wall that rises from the bottom member and a shoulder skirt that projects outwardly from the inside wall, forming a hand-sized frame or grip therearound.

The bottom member of the tray is formed with multiple channels and raised ribs between the channels. The channels all interconnect at one or more drainage spouts formed in the upper lip and shoulder skirt of the frame. The support plate is configured to detachably rest in a recessed step formed in the upper inside lip of the frame and is contactingly supported across the span of the bottom member by raised ribs. The serving support plate is easily unseated from the tray for cleaning, as in a dishwasher. The serving support plate is dimensioned to cover the central receptacle and, by resting on the raised ribs, provides a solid surface for supporting food items and drinking vessels. In addition, the ribbed channels also help to distribute liquid so that the weight of a liquid-loaded tray is not imbalanced when carrying.

The support plate is honeycombed with perforations therethrough for separating solids and liquids. The perforations are configured with size and shape for readily passing any liquid into the channels of the tray below while straining out any food solids. The sanitary placemat of the preferred embodiment is further characterized in that the volume of the channels formed in the bottom member is sufficient to hold a volume of fluids equivalent to a human portion. The volume of a human portion is preferably a cup or more, and most preferably up to two pints.

Accordingly, the objects and advantages of the sanitary placemat of the invention include:

To provide a child-friendly area for the child to eat, which allows mistakes, mishaps, spills and messes to occur but lessens the over-all mess and therefore makes clean up less “work” for the parent or guardian;

To provide a parent- and custodian-friendly eating area for a child, invalid, or inmate which helps to block potentially build up hard to clean stains on table top surfaces or cloths;

To provide a receptacle for spillage which is fully enclosed and allows for easy, quick and convenient after-meal cleanups;

To provide portable sanitary use, for example when eating on floors with carpets or in bed;

To prevent the spoon or other utensil, which is reversibly attached to the placemat, from dropping or being thrown onto the floor. A tethered utensil may be provided but the tether is reversibly detachable or breakable so that it will not bind around the child.

The support plate supports bowls, cups, eating utensils and food as desired and is perforated to permit rapid drainage of spillage. For liquids, the ribbed tray serves a reservoir for liquid spillage. The ribbed base gives structure and strength to the product and helps to spread/distribute spilled liquids evenly in the base. In one embodiment, the tray may have a pour spouts at the corners of a rectilinear frame, or may be generally crescent shaped with drains at the two horns of the crescent on either side of a central serving area.

Happily, the perforated plate also serves to separate and strain solids from liquids, advantageously permitting the user to remove the cover and dispose of any trapped solids in solid waste and then drain any liquids in the tray into a sink. Recycling of solid wastes is improved by this system.

### BRIEF DESCRIPTION OF THE DRAWINGS

The teachings of the present invention can be readily understood by considering the following detailed description in conjunction with the accompanying drawings, in which:

FIG. 1 is a CAD rendering of a first embodiment, showing tray, support plate, and tethered spoon. The tray is shaped with handholds at either end.

FIG. 2A is a cutaway view through a first embodiment, and in FIG. 2B the product is shown in section. FIG. 2C shows an alternate pattern of perforations useful in bordering the central serving area.

FIG. 3 is an exploded view showing the detachable support plate and corrugated interior surface of the tray.

FIG. 4 is a plan view of the upper side of the tray, showing interconnecting catchment channels between the raised ribs of the central corrugated bottom member.

FIG. 5 is a plan view of the underside of the tray.

### DETAILED DESCRIPTION

Although the following detailed description contains specific details for the purposes of illustration, one of skill in the art will appreciate that many variations and alterations to the following details are within the scope of the invention. Accordingly, the exemplary embodiments of the invention described below are set forth without any loss of generality to, and without imposing limitations upon, the claimed invention.

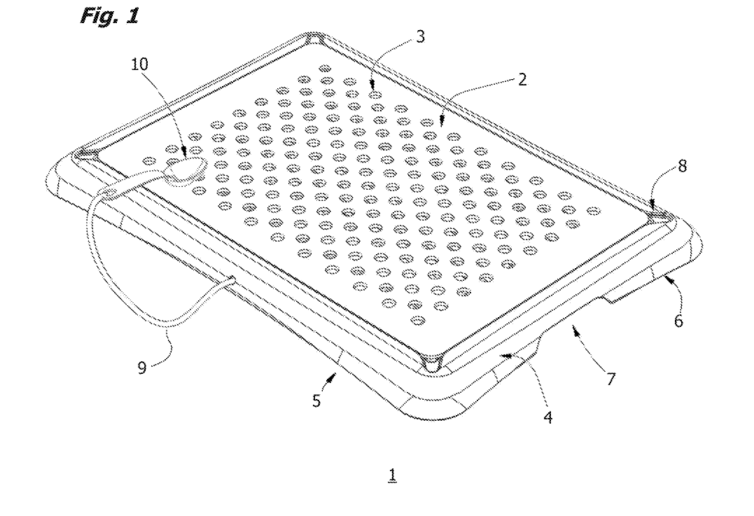

Turning now to the figures, FIG. 1 is a CAD rendering of a first embodiment of the sanitary placemat (1) of the invention. The fully assembled article includes a food service area, which is the flat planar surface (2) with perforations (3), a shouldered skirt (4) surrounding the food service area which forms the walls of a tray (5) with peripheral frame (6), and a central receptacle within the tray beneath the food surface area for receiving liquid draining through the perforations.

The shouldered tray frame (6) is formed with an outside wall or skirt (4), here a rounded, descending wall sculpted to support the user's wrist and forming a foundation for stable placement on a flat surface such as a table. Handholds (7) are configured in the base of the frame for ease in carrying. Drain spouts (8) are provided for ease of draining any liquids sequestered within the central tray receptacle.

The perforated food service surface is formed of a flat plate member (2), generally of a plastic, termed here the “support plate”. This support plate is configured to seat in a stepped recess or bezel formed on the upper inside lip of the shouldered frame of the tray and is detachable for cleaning. At each corner as shown, the upper lip is configured with a drain spout (8) for directing the flow of fluid during disposal.

In order to ensure easy access to the food serving surface, the lip of the tray frame is generally level with the support plate surface. Also shown is a tether (9) for securing an eating utensil (10) to the tray frame (6).

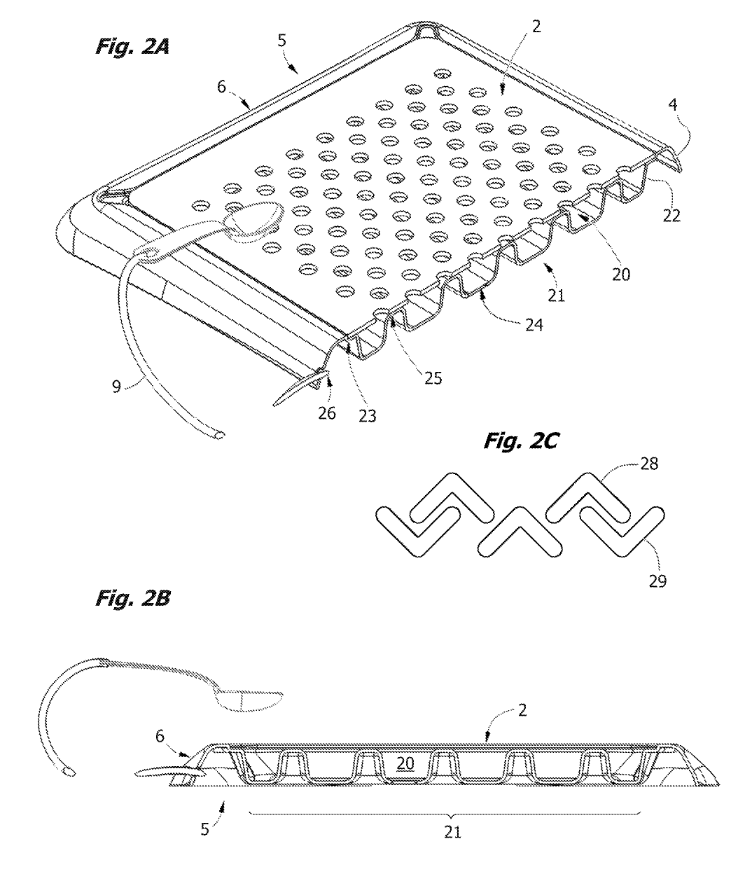

FIG. 2A is a cutaway view through a first embodiment, showing the two-piece construction of the placemat with supporting plate member (2) and tray member (5), and illustrates the interior volume or “central receptacle” (20) of the tray (5). The interior volume is a catchment for liquids. Solid waste too large to pass through the perforations is retained on the support plate for disposal in garbage, whereas liquid waste drains through the perforations and into the tray internal volume, where it is sequestered during the meal in the central receptacle.

The tray member consists of a peripheral frame (6) enclosing the central receptacle (20) and “bottom member” (21) contiguous with the frame. The profile of the undersurface forming the tray (5) is shown to be complex, and includes the exterior skirt (4), an interior inside wall (22) contiguous with and rising from the bottom member, the inside wall with bezeled inside upper lip (23) surrounding the central receptacle volume, and a plurality of channels (24) separated by raised ribs (25) for supporting the plate member (2) across its span over the central receptacle. Also shown is an insertion point (26) for securing the tether (9) to the frame.

In sectional view, FIG. 2B shows that the internal base area of the tray is corrugated for strength, including channels for containing liquid and ridges for supporting the support plate across its span over the central receptacle (20). The catchment volume of the channels is sufficient to contain at least or more than a cup of fluid, and preferably at least or more than a pint of liquid without overflowing when the tray is held level. When tipped, the channels convey fluid to the corners for draining. The ridges impart structural rigidity and stability to the support plate during the food service. The placemat is assembled from two pieces: a tray member (5) and a support plate member (2). Attachment of a food service utensil with a tether to the tray frame (6) is also shown.

FIG. 2C shows an alternate pattern of perforations useful in bordering the central serving area. The double row (28,29) of interlocking chevrons, the chevrons as perforations through a solid plate, is effective in more rapidly draining fluids into the central receptacle, thus preventing larger liquid spills from overflowing the edges of the support plate.

The tray receptacle is comprised of a bottom member (21) with ribs and channels which is framed on all sides by a hand-sized frame (6). The frame is formed of a peripheral inside wall, perimetrically disposed around the bottom member, and a projecting flange with outside shoulder or skirt. The inside wall rises from the bottom member and includes an upper lip, where the inside wall is continuous and integral with the bottom member, thus forming central receptacle or catchment vessel.

The upper lip is modified to form a recessed step for engagingly supporting the support plate. The edge of the support plate is complementary to the outline of the upper lip with the exception of the drain slots and may be configured to snap in place or otherwise securely engage the framing rail. Because it is supported across its span by ribs of the bottom member and at its edges, the support plate is a stable surface for supporting serving articles such as bowls, cups, glasses and plates.

Also shown in FIGS. 2A and 2B is a detail of a first end of the tether (9) and point of attachment (26) to the wall of the tray and a second end for attaching to a spoon. The tether may be made of flexible plastic or fiber. Alternatively, the first end of the tether may be modified as a fastening clip, and may be clippable between the upper lip and the support plate, or on the lower edge of the tray, or may be held by a rivet or detachable barb member to the placemat. In one embodiment, the tether is secured through a perforated hole in the support plate and held in place by a flexible bung that is press fit into a hole. Optionally the tether may be knotted or looped so as to be secured to the tray. In addition to spoons, the tether system may be used to secure other utensils such as forks, knives or straws if desired. The tether is optionally interchangeably attachable on the left or right of the serving area.

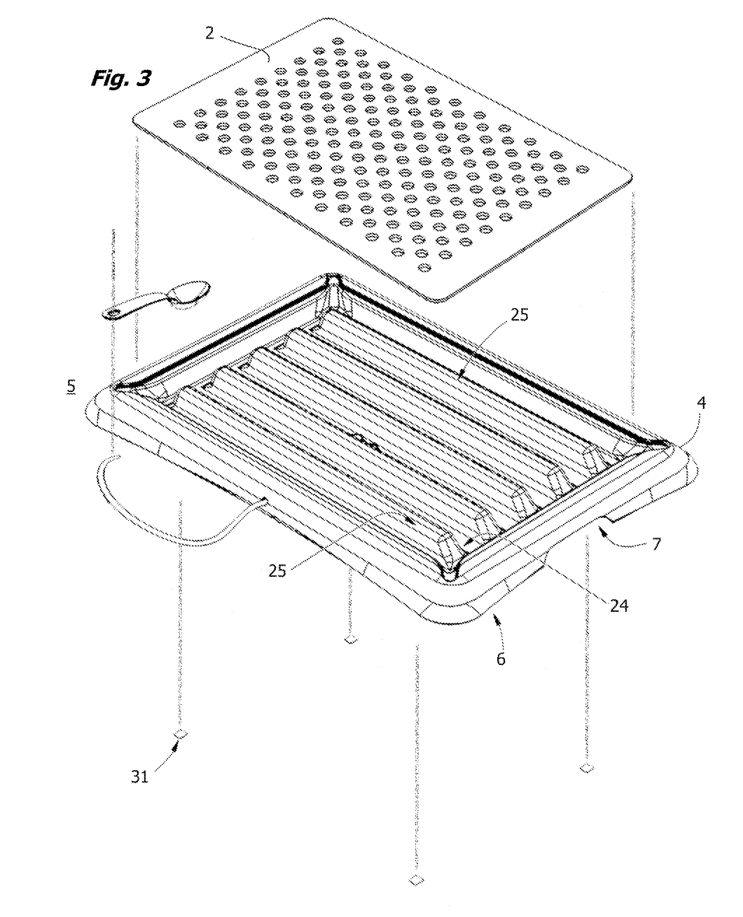

FIG. 3 is an exploded view showing the detachable support plate (2) and the ribbed interior surface of the tray (5). The ribbed structure of the bottom member and the surrounding frame (6) with outside shoulder skirt (4) are shown in perspective. This view illustrates use of the support plate (2) as a filter for separating or straining solid and liquid food waste. Food waste too large to pass through the perforations is readily lifted from the placemat and dumped to garbage and liquid waste may be drained from the open tray after the support plate is removed. In this way, the preparation of the article for washing is fast and efficient. Once separated, the support plate and supporting receptacle may be washed by hand or placed in a dishwasher as is customary for pots and pans.

The perforations are generally sized to separate or strain solid food from liquid, while rapidly draining liquid from the serving surface. Thus the perforations are generally greater than about one quarter of an inch in size, but less than or about one half inch in size. The perforations may vary in size over the surface of the serving area, and are optionally from pea sized to the size of “Cheerios®” cereal pieces. The perforations around the perimeter of the plate may be chevron-shaped, with alternating chevrons interdigitated point-to-wings so as to better entrap fluid rushing toward the edge of the placemat, such as when a cup or bowl is overturned.

Also shown are four feet (31) useful to prevent the tray from sliding during meal service. The four feet are attached at the underside corners of the bottom member and generally are selected from a non-skid material such as silicon rubber or polyurethane. In one embodiment, the feet may be suction cups.

In other embodiments, the rectilinear shape of the above embodiment is modified, for example as a crescent shape for more closely conforming to the torso of a seated or reclining person, with corresponding curvilinear peripheral frame and center receptacle having spaced central supporting ribs and more than one channel. The size of the placemat may be varied, for example small enough to fit the serving area of a highchair, or large enough for a buffet.

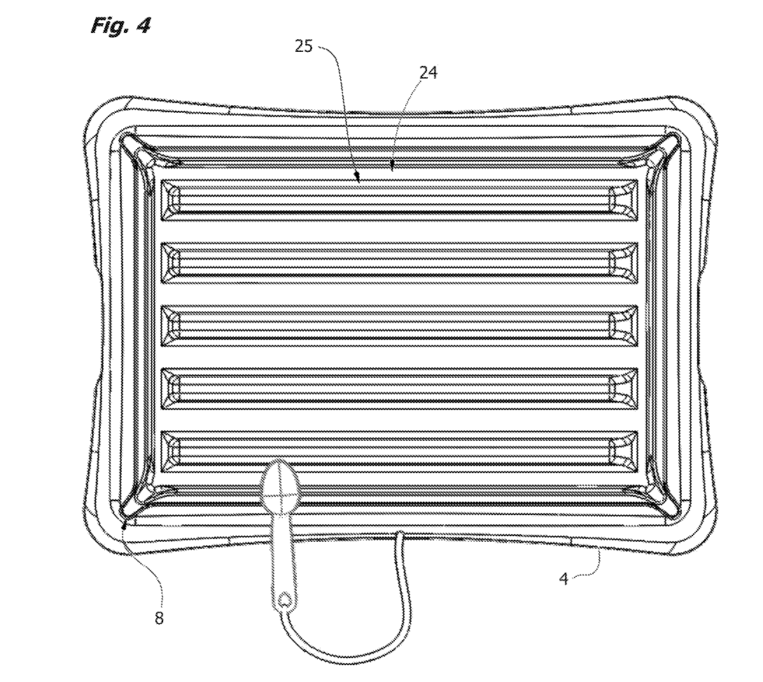

FIG. 4 is a plan view of a tray member (5) of the first embodiment, viewed from above, showing interconnecting channels (24) between the ribs (25) of the bottom member and surrounding frame with skirt 4. The channels are seen to fluidly communicate with drain spouts positioned at the corners of the tray. All channels intercommunicate and cumulatively form a common catchment volume.

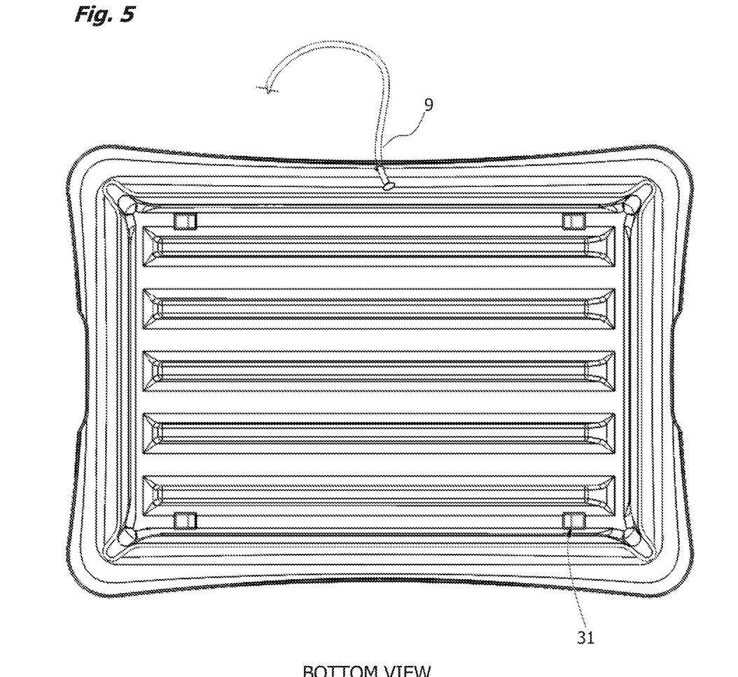

FIG. 5 is a view of the underside of the first embodiment, showing the channels of the bottom member contiguous with the peripheral frame, with ribs formed between the channels. Also shown is tether 9 with through-attachment to the frame, illustrating use of a soft bung to reversibly secure the tether.

Typically, tray embodiments of the invention are manufactured from plastic by injection molding, blow molding, or by vacuum forming. Suitable plastics include ABS, polypropylene, polyethylene, polycarbonate, polyimide, polyamide, melamine resins, cyclic polyolefins, composites or reinforced plastics such as fiberglass, and other thermoplastics known in the art. However, the tray may also be manufactured from sheet metal by press forming, from styrofoam, or from a fibrous material such as paper stock or cardboard. The tray may be transparent or opaque and is optionally disposable. Trays of dishwasher-safe materials are also conceived.

The support plate may be a molded or thermoformed plastic or a press-formed stainless steel plate. The support plate is provided with an array of perforations or holes formed as a mesh or lattice. The perforations are generally sized to be suitable for separating solid food materials from liquid, and may be the size of a little finger, for example, or large enough so that a finger can be inserted to remove the support plate from the supporting tray receptacle without becoming lodged therein. The perforations generally have a radius around the hole to promote fluid drainage from the serving surface. The support plate is generally opaque or translucent and may include graphics and color, or finishes such as metallic finish or a glossy finish. The support plate has low surface roughness and good liquid and chemical resistance so as to be readily cleaned and sanitized. In another embodiment, the support plate may be disposable, and may be provided with a bibulous absorbent core or liner under a liquid-resistant or impervious upper surface. The support plate is configured to be supported around the edges by the lip of the tray and in the center by the ribs of the tray.

The tether is generally a fiber or a plastic, and may be made from polyethylene, polypropylene, polyamides, or other soft plastic and includes a first end modified for attachment to the sanitary placemat, such as by a clip, rivet, barb, holdfast, loop, knot, or bung, and a second end modified as an eating utensil, or modified to attach an eating utensil.

Typically plastic receptacles and support plates of the invention are formed by injection molding, by vacuum forming, or by thermoforming. Blow molding may also be used. In another embodiment the rails are formed by blow molding and are hollow and tubular, with the upper and lower surface continuous between shoulder wall and interior rail wall.

In another embodiment, the placemat assembly includes a bottom member complementary in shape to the undersurface of the rail, which may be snapped onto the inside bottom edges of the shoulder wall. The base may be provided with feet formed as suction cups to adhere to any table-like surface so as to further improve the resistance of the placemat to upset or displacement from its position on a table.

The placemat assembly of the invention advantageously provides a stable food service surface for supporting food and eating utensils but is readily disassembled for cleaning. A tray with girder-like frame provides structural support and conceals an internal reservoir or receptacle for fluid wastes. The perforated surface of the covering support plate is configured so that liquid residues drain into the tray and are sequestered there and solid residues are retained on the support plate and may be easily disposed of for recycling.

Surprisingly, the receptacle tray with perforated plate also finds use in recycling, where liquid waste is generally consigned to the sink, but solid waste may be used as garden compost. The size of the perforations may be selected to grade the waste, separate solids, and drain excess fluid before recycling. Many municipalities collect solid food waste for recycling and the perforated plate facilitates its collection.

Sanitary placemats of the invention also find use in institutions where it is desirable to minimize the effort of food service and where patients or inmates may have difficulty handling food and drink, and in busy homes with children, where parents are frequently hard pressed to clean up after feeding a young child.

Unless the context requires otherwise, throughout the specification and claims which follow, the word “comprise” and variations thereof, such as, “comprises” and “comprising” are to be construed in an open, inclusive sense, that is as “including, but not limited to”.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

All of the U.S. patents, U.S. patent application publications, U.S. patent applications, foreign patents, foreign patent applications and non-patent publications referred to in this specification, are incorporated herein by reference, in their entirety. Aspects of the embodiments can be modified, if necessary to employ concepts of the various patents, applications and publications to provide yet further embodiments.

While the above is a complete description of the preferred embodiments of the present invention, it is possible to make, use or sell various alternatives, modifications and equivalents. Therefore, the scope of the present invention should be determined not with reference to the above description but should, instead, be determined with reference to the appended claims, along with their full scope of equivalents. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A two-piece sanitary placemat for food service, which comprises:
a) a tray member with central receptacle defined by a bottom member and an enclosing frame, said frame formed of a peripheral inside wall with upper lip rising from said bottom member and a shoulder skirt outwardly projecting from said upper lip, said bottom member with a plurality of channels and raised ribs therebetween, the channels interconnecting at one or more common drainage spouts formed in said shoulder skirt;
b) a serving area comprising a support plate with flat upper surface for supporting food service items, said support plate having dimensions for covering said central receptacle and detachably seating in a recessed step formed on said upper lip;
c) wherein said support plate is contactingly supported by said ribs of said bottom member and honeycombed with perforations therethrough;
and further characterized in that said perforations are sized to separate solids and liquids for separate disposal and the channels are configured with a volume equivalent to a human liquid portion size, said volume for sequestration of said liquid portion therein.

2. The sanitary placemat of claim 1, wherein said quantity is in the range of one cup to two pints.

3. The sanitary placemat of claim 1, wherein said perforations form a pattern of two rows of chevrons interdigitated point-to-wings at the border of said support plate, said rows of chevrons for preventing liquid from flowing over said upper lip.

4. The sanitary placemat of claim 1, comprising a tether for tethering an eating utensil, said tether reversibly attaching at a first end to said enclosing frame and at a second end to said utensil.

5. The sanitary placemat of claim 4, wherein said tether is interchangeably attachable on a right aspect or a left aspect of said placemat.

6. The sanitary placemat of claim 1, wherein said placemat is stackable and further comprises non-skid footings attached to said bottom member for stable support.

7. The sanitary placemat of claim 1, wherein said tray is rectilinear in shape and a drain spout is configured at each corner of said shoulder skirt.

8. The sanitary placemat of claim 1, wherein said tray is crescent shaped and a drain spout is configured at each horn of the crescent.

9. The sanitary placemat of claim 1, wherein said tray and said support plate are fabricated of a dishwasher resistant material and may be washed separately.

10. The sanitary placemat of claim 1, wherein said tray and said support plate are fabricated of a plastic or of stainless steel.

11. The sanitary placemat of claim 1, wherein said support plate is disposable and incorporates an absorbent liner under a liquid-resistant or impervious upper surface.
